(19) United States
(12) Patent Application Publication
(10) Pub. No.: US 2012/0180325 A1
(43) Pub. Date: Jul. 19, 2012

(54) PAPER CUTTER

(76) Inventors: Jin-Song WU, Guangdong (CN); Ye MA, Guangdong (CN)

(21) Appl. No.: 13/213,733

(22) Filed: Aug. 19, 2011

(30) Foreign Application Priority Data
Jan. 18, 2011 (CN) 201120022620.7

(51) Int. Cl. B26B 5/00

(52) U.S. Cl. 30/330

(57) ABSTRACT

A paper cutter comprises a cutter handle, a cutter head connected to the cutter handle, and a cutter blade mounted in the cutter head. The cutter head comprises a lower cutter head member defining an accommodation chamber for accommodating the cutter blade, and an upper cutter head member accommodating the lower cutter head member in an accommodation chamber with an open at one side therein. The lower cutter head member and the upper cutter head member are respectively made of a stainless steel sheet member by stamping.

### BACKGROUND OF THE INVENTION

1. Field of the Invention

The present invention relates to metal cutter fabrication technology and more particularly, to a new design of paper cutter.

2. Description of the Related Art

Conventional paper cutters commonly comprise a cutter handle and a cutter head connected to the cutter handle. The cutter head may be formed of a plurality of stainless steel blades arranged in a stack. In some other designs, the cutter head is a cast member. Conventional paper cutters using a cutter head of either of the aforesaid two designs commonly have the drawbacks of high manufacturing cost, complicated manufacturing process, heavy cutter head and inconvenience of use.

### SUMMARY OF THE INVENTION

The present invention has been accomplished to eliminate the drawbacks of the aforesaid prior art designs. It is the main object of the present invention to provide a paper cutter, which has a simple and compact design, convenient for use.

To achieve this and other objects of the present invention, a paper cutter A paper cutter comprises a cutter handle, a cutter head connected to the cutter handle, and a cutter blade mounted in the cutter head. The cutter head comprises a lower cutter head member defining an accommodation chamber for accommodating the cutter blade, and an upper cutter head member accommodating the lower cutter head member in an accommodation chamber therein. The lower cutter head member and the upper cutter head member are respectively made of a stainless steel sheet member by stamping.

Further, the cutter blade comprises a plurality of retaining notches. Further, the upper cutter head member comprises a plurality of pins adapted for securing to the retaining notches of the cutter blade.

Further, the lower cutter head member comprises an oblong slot and a compression spring mounted at one end in the oblong slot. The upper cutter head member comprises a V-slot, and a control key inserted through the V-slot and the oblong slot of the lower cutter head member and supported on the compression spring and movable along the V-slot between an upper end position and a lower end position to lock/unlock the cutter blade.

Further, the lower cutter head member comprises a notch located on a top side thereof corresponding to the retaining notches of the cutter blade.

### BRIEF DESCRIPTION OF THE DRAWINGS

FIG. 1 is a schematic drawing illustrating the outer appearance of a paper cutter in accordance with the present invention.

FIG. 2 is a schematic drawing of the present invention, illustrating a cutter blade replacement operation.

FIG. 3 is a schematic assembly view of the cutter head and cutter blade of the paper cutter in accordance with the present invention.

FIG. 4 is a schematic drawing of the present invention, illustrating the cutter blade set in the lower cutter head member.

FIG. 5 is a schematic drawing of the present invention, illustrating the lower cutter head member accommodated in the upper cutter head member.

FIG. 6 is a schematic structural view of a part of the present invention, illustrating the arrangement of the control key and the compression spring in the lower cutter head member.

FIG. 7 is a schematic plain view of the upper cutter head member in accordance with the present invention.

FIG. 8 is a schematic bottom view of the cutter head, illustrating the lower cutter head member accommodated in the upper cutter head member.

### DETAILED DESCRIPTION OF THE INVENTION

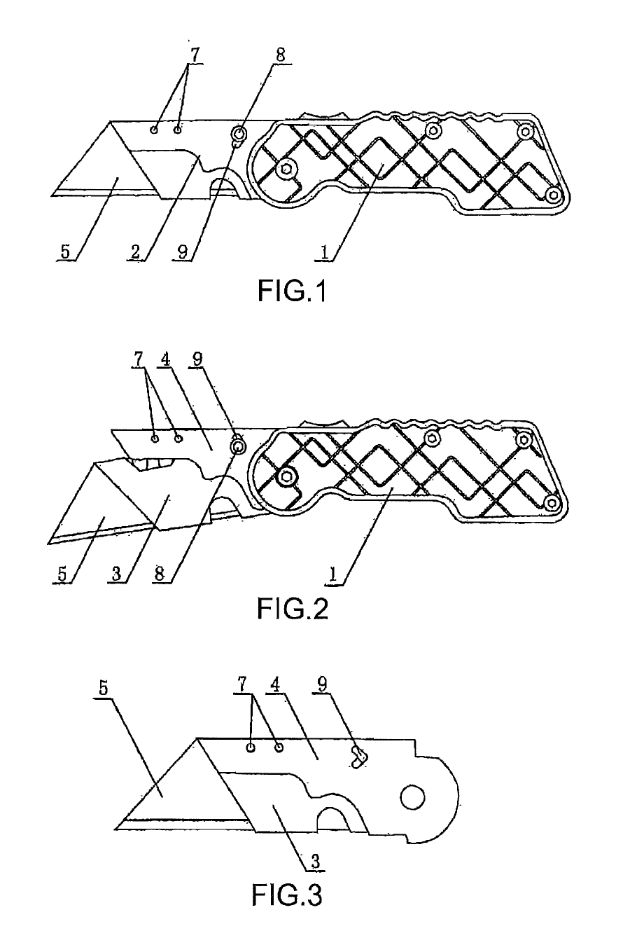

As shown in FIGS. 1˜8, a paper cutter in accordance with the present invention is shown comprising a cutter handle 1, a cutter head 2 connected to the cutter handle 1, and a cutter blade 5 mounted in the cutter head 2. The cutter head 2 comprises a lower cutter head member 3 and an upper cutter head member 4. The upper cutter head member 4 has an accommodation chamber with an open at one side. The lower cutter head member 3 and the upper cutter head member 4 are respectively made of a stainless steel sheet member by stamping. The lower cutter head member 3 is pivoted inside the accommodation chamber defined in the upper cutter head member 4. The lower cutter head member 3 has an accommodation chamber with an open facing the upper cutter head member 4. The cutter blade 5 is accommodated in the accommodation chamber defined in the lower cutter head member 3. The upper cutter head member 4 comprises a plurality of pins 7 adapted for securing to respective retaining notches 6 at the top side of the cutter blade 5, and a control key 8 operable to lock/unlock the cutter blade 5. The control key 8 is movably inserted through a V-shaped slot 9 providing on the upper cutter head member 4 and an slot 10 providing on the lower cutter head member 3 and supported on an elastic member, for example, compression spring 11 at one end of the slot 10.

The lower cutter head member 3 further has a notch 12 located on the top side near the upper cutter head member 4 thereof.

The operation of the paper cutter will be outlined hereinafter.

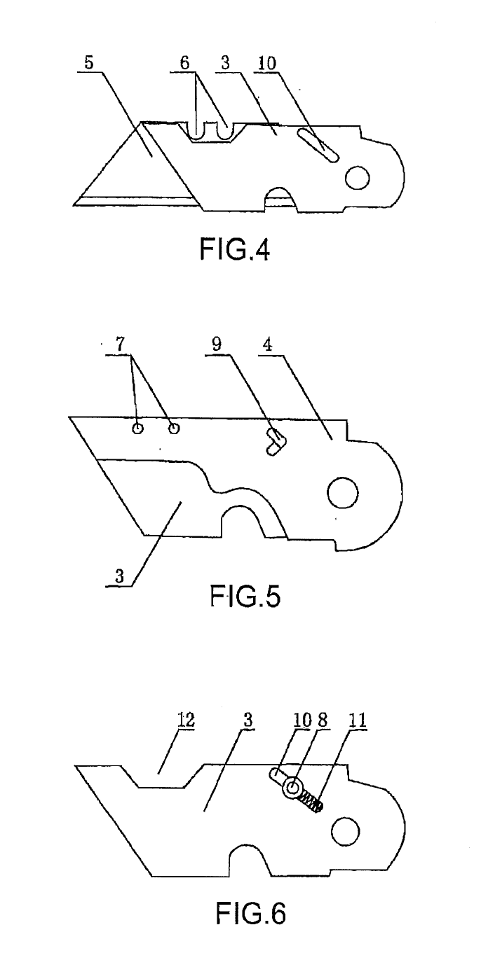

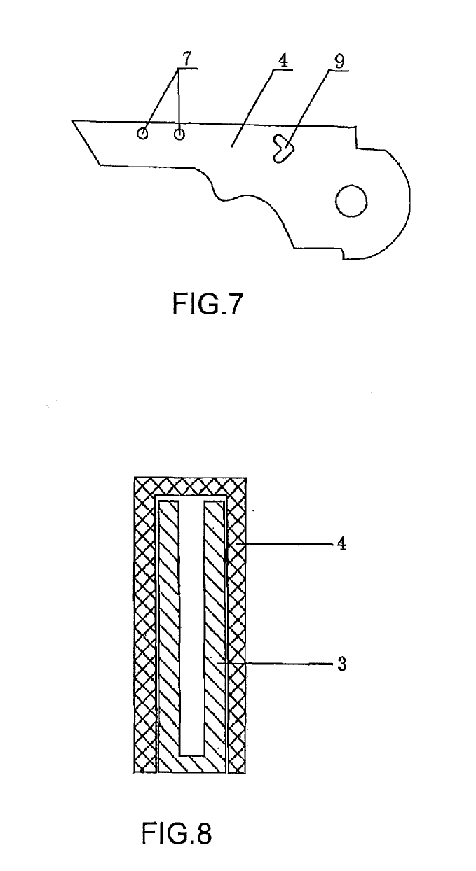

FIG. 1 illustrates a status of use of the paper cutter in accordance with the present invention. When wishing to replace the cutter blade 5, move the control key 8 from an upper end position at one end of the V-shaped slot 9 (see FIG. 1) to a lower end position at the other end of the V-shaped slot 9 (see FIG. 2) to turn the lower cutter head member 3 out of the accommodation chamber defined in the upper cutter head member 4. When reached the lower end position, the compression spring 11 in the slot 10 imparts a pressure to the control key 8, holding down the control key 8 in the lower end position. Thereafter, put the cutter blade 5 into the accommodation chamber in the lower cutter head member 3. At this time, the retaining notches 6 of the cutter blade 5 are in kept in the notch 12 of the lower cutter head member 3, as shown in FIG. 4. Thereafter, move the lower cutter head member 3 upwards to force the compression spring 11 against the control key 8, thereby moving the control key 8 from the lower end position back to the upper end position to lock the lower cutter head member 3 to the upper cutter head member 4, and at the same time, the pins 7 are respectively forced into engagement with the retaining notches 6 of the cutter blade 5.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A paper cutter, comprising: a cutter handle (1), a cutter head (2) connected to said cutter handle (1), and a cutter blade (5) mounted in said cutter head (2), wherein said cutter head (2) comprises a lower cutter head member (3) and a upper cutter head member (4), said lower cutter head member (3) defining an accommodation chamber for accommodating said cutter blade (5), and said upper cutter head member (4) having an accommodation chamber with an open at one side and said lower cutter head member (3) being pivoted in said accommodation chamber, said lower cutter head member (3) and said upper cutter head member (4) being respectively made of a stainless steel sheet member by stamping.

2. The paper cutter as claimed in claim 1, wherein said cutter blade (5) comprises a plurality of retaining notches (6); said upper cutter head member (4) comprises a plurality of pins (7) adapted for securing to said retaining notches (6) of said cutter blade (5).

3. The paper cutter as claimed in claim 1, wherein said lower cutter head member (3) comprises a slot (10) and a compression spring (11) mounted at one end in said slot (10); said upper cutter head member (4) comprises a V-shaped slot (9), and a control key (8) inserted through said V-shaped slot (9) and said slot (10) of said lower cutter head member (3) and supported on said compression spring (11) and movable along said V-shaped slot (9) between an upper end position and a lower end position to turn the lower cutter head member (3) out of the accommodation chamber defined in the upper cutter head member (4).

4. The paper cutter as claimed in claim 1, wherein said lower cutter head member (3) comprises a notch (12) located on a top side thereof corresponding to said retaining notches (6) of said cutter blade (5).
